(19) United States
(12) Patent Application Publication
(10) Pub. No.: US 2021/0310661 A1
(43) Pub. Date: Oct. 7, 2021

(54) METHOD FOR OPERATING A DOMESTIC COOKING APPLIANCE AND DOMESTIC COOKING APPLIANCE

(71) Applicant: BSH Hausgeräte GmbH, Munich (DE)

(72) Inventors: Astrid Eigner, Unterneukirchen (DE); Kathrin Krolikowski, Roding (DE)

(21) Appl. No.: 17/261,891

(22) PCT Filed: Aug. 6, 2019
(86) PCT No.: PCT/EP2019/071066

§ 371 Date: Jan. 21, 2021

(30) Foreign Application Priority Data
Aug. 24, 2018 (DE) 10 2018 214 360.9

(51) Int. Cl. F24C 7/08; F24C 15/00

(52) U.S. Cl. CPC F24C 7/085; F24C 15/003

(57) ABSTRACT

In a method for operating a household cooking appliance with a cooking chamber, a humidity value is monitored in the cooking chamber, and a sign is output when the humidity value reaches or falls below a predetermined threshold value.

The invention relates to a method for operating a household cooking appliance with a cooking chamber, in which a humidity value in the cooking chamber is monitored. The invention also relates to a household cooking appliance, having a cooking chamber and a control device, wherein the control device is designed to allow the method to proceed. The invention can be applied particularly advantageously to household cooking appliances, in particular ovens, with and without a steam generator.

DE 10 2008 040 398 A1 discloses a cooking appliance device with a control unit, which is provided for controlling a characteristic, which deviates from a temperature characteristic, in a cooking chamber. The deviating characteristic can be an air humidity characteristic.

DE 10 2012 200 304 A1 discloses a cooking appliance with a cooking chamber and with at least one lambda probe for detecting at least one property of the cooking chamber, in particular a humidity content.

WO 2004/077952 A1 discloses a method for controlling a cooking process in the cooking chamber of a cooking appliance as a function of the dew point in the interior of the cooking appliance, comprising the following steps: e) introducing at least one item of cooked food and at least one accessory, such as in the form of a food container, a saucer, a plate, a support, a ladder, a tray rack and/or a tray rack carriage, and/or at least one reference element into the cooking chamber f) determining at least one climate parameter, in particular relating to temperature and humidity, in the cooking chamber, on the cooked food, in particular on the surface of the cooked food, on the accessory, in particular on the surface of the accessory, and/or on the reference element, in particular on the reference element surface, at least partially during the cooking process g) determining the, in particular current, extent that the dew point on the cooked food and/or on the accessory and/or on the reference element is exceeded or fallen below, in particular by way of an evaluation unit and d) adjusting the climate parameter in the cooking chamber during the cooking process as a function of the extent, determined in step c), that the dew point is exceeded or fallen below, so that the climate in the cooking chamber, in particular the humidity in the cooking chamber, the supply of humidity into the cooking chamber and/or the discharge of humidity from the cooking chamber, is dew-point controlled.

US 2009/0134141 A1 discloses a method for controlling the humidity level in a cooking chamber of an oven, which is provided with a steam generator. The method comprises monitoring the power supplied to the steam generator, in order to keep the power at a predetermined value, which correlates with a selection, generated by the user, of a plurality of different values which correspond to predetermined values, of at least one cooking parameter, in particular the degree of browning of the foodstuff.

US 2011/0278279 A1 discloses a convection and steam oven with a housing, which contains a cooking chamber for receiving foodstuff, means for warming the atmosphere in the cooking chamber, means for generating steam, means for discharging steam and a system for detecting and controlling the humidity in the cooking chamber. The humidity detection and regulation system contains at least a first and a second temperature detection device, wherein the humidity detection and control system is suited to operating the steam generation device and the steam discharge device in response to the temperature values detected by the first and second temperature detection device.

The object of the present invention is to at least partially overcome the disadvantages of the prior art and in particular to provide an option for improving a cooking result of foods in a cooking chamber of a household cooking appliance as a function of a humidity content in the cooking chamber.

This object is achieved according to the features of the independent claims. Advantageous embodiments form the subject matter of the dependent claims, the description and the drawings.

The object is achieved by a method for operating a household cooking appliance with a cooking chamber, in which
a humidity value or humidity content in the cooking chamber is monitored, and
when the humidity value reaches or falls below a predetermined threshold value, a first sign is output to a user.

This method advantageously makes it possible for a user to be able to improve a cooking result of cooked food (e.g. foods or meals) in a particularly simple manner, since he is given an option, by means of the sign, to influence the cooked food individually with a suitable humidity level in the cooking chamber. By outputting the sign with the suitable humidity level, the further advantage is achieved that a user does not himself need to determine the point in time of the suitable humidity level; this avoids an increased/unnecessary opening of the cooking chamber door with the energy loss associated therewith.

In particular, the advantage is achieved that cooked food can be prevented from drying up, since by means of the sign a user can be made aware to increase the humidity by adding water or water vapor. For instance, this can avoid burning due to excessive dryness in the cooking chamber, e.g. herb crusts. A further advantage is that the user himself can determine the added quantity of water, in order to achieve an individual cooking result. The method therefore advantageously avoids using an appliance-side humidity control, which can frequently only be matched imprecisely to the cooked food.

Another advantage is that the method can also be used with cooking appliances without the automatic addition of steam or with a deactivated humidity control.

In one development the household cooking appliance has an oven.

The household cooking appliance also has the option of monitoring a humidity value or humidity content in the cooking chamber. To this end, the household cooking appliance can have one or more sensors. The at least one sensor can measure the humidity (absolute humidity or relative humidity) directly or indirectly. An indirect measurement can be understood to mean a measurement of a parameter of the cooking chamber or the cooking chamber atmosphere, which does not show the humidity as such, but from which the humidity can be derived or calculated, e.g. oxygen partial pressure. Such a sensor can be a Lambda probe, for instance.

In order to carry out the method, the humidity value can be measured or derived directly and then used as a measured variable. Alternatively, a value of a parameter, which is representative of the humidity, from which the humidity can be derived or calculated, can be used directly, in other words without calculating the humidity value, e.g. the oxygen partial pressure as such.

The sign to the user can be output on the household cooking appliance (e.g. on a display unit or display) and/or transmitted to a user terminal such as a smartphone, a tablet PC, a laptop etc. e.g. as an electronic message.

In one embodiment the sign comprises a suggestion to increase a humidity value or humidity content in the cooking chamber. As a result, a user is advantageously made aware that he should now introduce water or water vapor into the cooking chamber in order to achieve a particularly good cooking result. Contrary to an automatic humidity control, the user is herewith given the option of himself selecting the quantity of water or steam. The user may also consciously refrain from adding water or steam at the current point in time, if he considers this to make sense, e.g. after checking the food.

In one embodiment, the household cooking appliance is configured without a steam generator, i.e. the household appliance has no steam generator. A household cooking appliance without a steam generator can comprise a household cooking appliance, in particular oven, without a steam generation function. The user can then supply water into the cooking chamber, by providing water on the base of the cooking chamber, by placing a tray filled with water into the cooking chamber or by adding water to the cooked food.

In one embodiment, the household cooking appliance has a steam generator which is embodied to manually trigger at least one steam boost. The user can then supply water vapor in an individual quantity into the cooking chamber, by manually activating the steam generator. Such a steam generator can be attached in particular outside of the cooking chamber. In order to carry out the method, an automatic humidity control is in particular deactivated.

The method can however also be used advantageously if the household cooking appliance has an evaporator tray which is present in a base of the cooking chamber. The disadvantage of the evaporator tray consists in water located therein then being output in an uncontrolled manner into the cooking chamber if the cooking chamber temperature noticeably exceeds the boiling temperature of water. The method can be carried out with an initially filled evaporator tray or with an initially empty evaporator tray.

In one embodiment, the sign comprises a suggestion to add food to the cooking chamber. The advantage is therefore achieved that food can be added at the correct point in time/ humidity value of the cooking process—also irrespective of a possible increase in a humidity in the cooking chamber. For instance, a sign to add herbs or spices can be given if the humidity value in the cooking chamber has fallen so much to the threshold value that these can develop or release their flavors particularly effectively.

The information contained in the sign is basically not restricted, however.

In one embodiment
the humidity value in the cooking chamber continues to be monitored after outputting the sign and
when the humidity value reaches or falls below a predetermined threshold value, a further sign is output.

As a result, the advantage is achieved that a user can be informed of the humidity content or moisture content in the cooking chamber more precisely, in particular in several stages. In particular, the further threshold value can correspond to a lower humidity value in the cooking chamber. The further advantage is therefore achieved that the sign output when the further threshold value is achieved can be used as a “safety level”, which can advise a user of a critically low humidity value having been reached. Different types of sign (e.g. relating to an addition of water and a treatment of foods in other ways) or less urgent and more urgent signs can also be output for different humidity levels. The output signs can also be the same, however. The above steps can also proceed repeatedly, i.e. the humidity value in the cooking chamber continues to be monitored after the further sign is output and when the humidity value reaches or falls below another further predetermined threshold value, another sign is output, etc.

In one embodiment, a threshold value is determined from a reference humidity value determined at a predetermined point in time, multiplied by a predetermined associated proportional factor. This can also be expressed as T=fr·y, wherein T refers to the threshold value, fr to the reference humidity value and y to the proportional factor. The proportional factor lies in particular in a region 0<y<1, especially in a region 0.5<y<0.9.

If the humidity value in the cooking chamber continues to be monitored after a sign is output, the threshold values of different monitoring sections or monitoring loops can differ.

In one development, before firstly monitoring the humidity value in the cooking chamber at a (reference) point in time t0, the humidity value f (t0) then prevailing in the cooking chamber is stored or set as a first reference humidity value fr (t0), i.e. it is assumed that fr (t0)=f(t0). A first threshold value T(t0)=fr (t0)·y, which is compared with the current humidity value f (t) with t>t0 during the monitoring process, is determined therefrom in particular at consecutive, in particular regular, intervals. If the current humidity value f(t) reaches or falls below the threshold value T (t0), i.e. it is determined that f (t)≤T (t0) applies, a sign is output. Following the sign, at point in time t1>t0, the humidity value f(t1) then prevailing in the cooking chamber can be stored or set as a second reference humidity value fr (t1), i.e. it is assumed that fr (t1)=f(t1). A second threshold value T (t1)=fr (t1)·y is determined herefrom, which, during the monitoring, is compared with the current humidity value f(t) with t>t1, in particular at consecutive, in particular regular, intervals. If the current humidity value f(t) reaches or falls below the threshold value T (t1), i.e. it is determined that f (t)≤T (t1), a further sign is output. This can be carried out repeatedly for different reference points in time t0, t1, t2, . . . etc.

In one development, the proportional factors y for calculating at least two different threshold values T (ti) and T (ti) are the same or constant.

In one development, the proportional factor y for calculating different threshold values T (ti) and T(ti) is different.

In one embodiment, a desired humidity level (e.g. dry or humid) in the cooking chamber is queried at the start of the method from a group of several predetermined humidity levels and the proportional factor is fixed or set as a function of the selected humidity level. The advantage is therefore achieved that a user is able to match the humidity level to the cooked food in a particularly user-friendly manner. For instance, a higher humidity level or a (more) humid cooking chamber atmosphere can be particularly suited to specific meals such as stews or dishes coated in herbs, while a lower humidity level or a dry(er) cooking chamber atmosphere can be particularly suited to meals in which herbs or other spices are to be added into the cooking chamber which develop their flavor particularly effectively only with dryer cooking chamber atmospheres.

In general, the proportional factor can be set individually by a user, e.g. matched to a specific food or meal. The user can set the proportional factor on the basis of separate notices, for instance, tables or in a menu-controlled manner by way of the household cooking appliance.

In one embodiment, the proportional factor is set automatically as a function of a selected cooking program.

The object is also achieved by a household cooking appliance, which is designed to allow the method to proceed as described above. The household cooking appliance can be embodied analogously to the method and has the same advantages.

The household cooking appliance has in particular a cooking chamber and a control device, wherein the control device is designed to allow the method to proceed. The household cooking appliance can be embodied analogously to the method and produces the same advantages.

In one embodiment, the household appliance is a household appliance, in particular oven, without a steam generator.

In one embodiment, the household appliance, in particular oven, also has a steam generator functionality. To this end, it can have a steam generator arranged outside of the cooking chamber. In particular, a humidity control can then be deactivated and a manual activation of the steam generator can be activated.

The above-described properties, features and advantages of this invention and the manner in which these are achieved will become clearer and more readily understandable in connection with the following schematic description of an exemplary embodiment, which will be described in further detail making reference to the drawings.

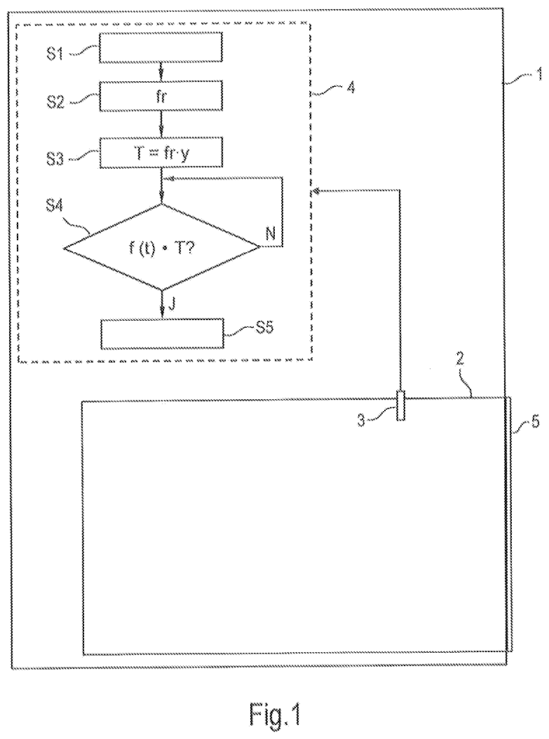

FIG. 1 shows a flow chart of the method according to a first exemplary embodiment with an associated household cooking appliance;

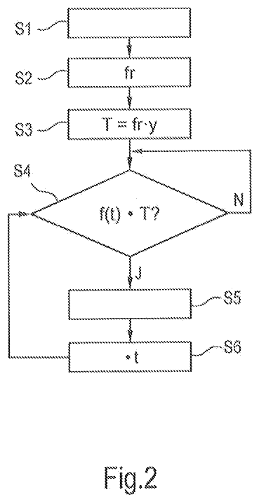

FIG. 2 shows a flow chart of the method according to a first exemplary embodiment;

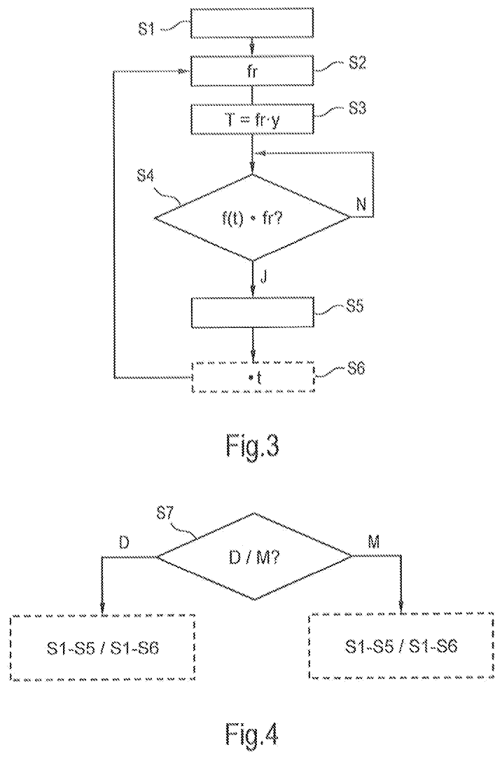

FIG. 3 shows a flow chart of the method according to a third exemplary embodiment;

FIG. 4 shows a flow chart of the method according to a fourth exemplary embodiment.

FIG. 1 shows a flow chart of the method according to a first exemplary embodiment.

In a step S1, a cooking operation of a household cooking appliance 1 is started. This can take place e.g. by a user activating a start button and/or in a program-controlled manner. The user may have entered settings associated with carrying out the cooking operation (e.g. a desired target cooking chamber temperature, process duration, type of cooked food etc.) directly and/or by way of selecting a cooking program.

The household cooking appliance 1 has a cooking chamber 2 and a sensor 3 suited to determining an e.g. absolute or relative humidity in the cooking chamber 2, e.g. a lambda probe. The sensor 3 is connected to a control device 4, which can evaluate the measured values of the sensor 3. In the event of a presence of a Lambda probe, the control device 4 can be designed, for instance, to convert an oxygen partial pressure measured thereby into corresponding humidity values. However, it is also possible to dispense with the conversion and the measured value as such for carrying out the method can be used as a representative of a humidity value.

In a following step S2, a current humidity value of the cooking chamber 2 or a cooking chamber atmosphere in the cooking chamber 2 is determined by means of the control device 4 at an initial point in time t0 as a reference humidity value fr (t0) or reference humidity content, e.g. in the presence of an oxygen sensor represented by a value pO2 (t0) of an oxygen partial pressure. The humidity value can represent an absolute or relative humidity.

In a step S3, a threshold value T according to T=fr (t0)·y with y<1 is calculated from the reference humidity value fr (t0) by means of the control device 4. The threshold value T therefore corresponds to a proportion of humidity of the reference humidity value fr (t0) which is fixed by means of the “proportional factor” y.

In a fourth step S4, a current humidity value f(t) in the cooking chamber 2 is monitored by means of the control device 4 at the following points in time t with t>t0. If the current humidity value f(t) is above the threshold value T (“N”), the monitoring is continued in a loop-type manner, e.g. at regular consecutive points in time t.

If, however, in step S4 the humidity value f(t) reaches or falls below the threshold value T (“J”), in a step S5, a sign or a message is output to a user and makes the user aware of the drop in the current humidity value f(t) to the threshold value T. The sign can be output to a display device of the household cooking appliance and/or transmitted to a user terminal (e.g. a smartphone) of the user. The sign can be output in an acoustically highlighted manner, e.g. by outputting a supervisory tone.

Where necessary, the user can increase the humidity value in response to the sign. This can take place in household cooking appliances without a steam generator, for instance, so that a user opens a cooking chamber door 5 which closes the cooking chamber 2 and supplies water into the cooking chamber 2. With household cooking appliances with a steam generator, the user can, for instance, actuate a corresponding actuation field on the household cooking appliance or the household cooking appliance in a remote controlled manner by way of the user terminal, in order to activate the steam generator for outputting steam into the cooking chamber 2, e.g. in the form of one or more steam boosts.

FIG. 2 shows a flow chart of the method according to a second exemplary embodiment. In this exemplary embodiment, steps S1 to S5 are carried out similarly to the method according to a first exemplary embodiment.

However, following step S5, in a step S6 the control device 4 waits for a predetermined waiting time (duration) Δt (e.g. one or two minutes) and then branches back to step S4. If the humidity value is not increased to above the threshold value T within the waiting time Δt, the sign is output again in step S4.

In one variant, the waiting time Δt can begin with outputting the sign in step S5.

In another variant, the waiting time Δt can begin with identifying an opening and closing process of the cooking chamber door 5, possibly under the boundary condition that the cooking chamber door 5 has been opened for a minimum duration. This variant is particularly advantageous for household cooking appliances without a steam generator or only with an evaporator tray, since it provides an indication that the user has filled liquid into the cooking chamber 2 and to this end has opened the cooking chamber door 5 for a sufficiently long period of time.

In yet another variant, the waiting time Δt can occur by a user triggering a steam boost if the household cooking appliance is equipped with a steam generator.

In one development, the signs output in step S5 are the same. In another development, the signs can differ. Therefore a sign which follows the first sign can advise a user more urgently as to the threshold value T being reached.

FIG. 3 shows a flow chart of the method according to a third exemplary embodiment. In this exemplary embodiment, the steps S1 to S5 are carried out similarly to the method according to the first or the second exemplary embodiment.

By outputting the sign in step S5 (optionally after a waiting time Δt similar to step S6 according to the second exemplary embodiment), a branch back to step S3 is made. As a result, at a point in time t1 with t1>t0, the humidity value f(t) is fixed as the new reference humidity value fr (t1) and method step S4 proceeds again with a new threshold value T=fr (t1)·y.

If in step S4 the current humidity value f(t) reaches or fails to reach the new threshold value T (“J”), in step S5 a sign is again output to a user which makes the user aware that the current humidity value f(t) has dropped to the new threshold value T.

This adjustment of the reference humidity value fr and thus of the threshold value T can essentially proceed as often as necessary or be restricted to a maximum number. In particular, it is possible only to use the two reference humidity values fr (t0) and fr (t1) or only the threshold values T (t0) and T (t1).

The threshold values T (ti) with i=0, 1, 2, . . . may therefore vary since the reference humidity values fr (ti) defined at points in time ti may be different.

In one development, the proportional factors y are constant during the method.

In another development, at least two proportional factors y (ti), y (tj) with j>i, which are used to calculate the threshold values T (ti) or T (tj), can be different. In particular, with a first looping from step S4, the proportional factor y (t0) can be higher than the proportional factor y (t1) with a further looping from step S4 after a jump from step S5 or S6. While the proportional factor y (t0) can correspond to a value for achieving a particularly good cooking result, the proportional factor y (t1) can then indicate that a critical humidity range has been reached and thus correspond to a “safety value”.

The signs output after the first looping from step S4 and after the further looping from step S4 can optionally also differ here. Therefore the first sign can read e.g. “Please supply water” or similar, while the second sign (“Safety advice”) can read e.g. “Caution, the cooking chamber is critically dry. Please supply water” or similar. However, the signs can alternatively also be the same.

FIG. 4 shows a flow chart of the method according to a fourth exemplary embodiment. According to the method, a step S7 now precedes the steps S1 to S5 or S1 to S6 according to the first to third exemplary embodiment.

In step S7, the control device 4 queries whether a user would like to select a specific type of cooking chamber atmosphere or “cooking chamber environment”, determined by way of its humidity level, from a group comprising several types of cooking chamber atmospheres. Here, by way of example, a possible selection of two cooking chamber atmospheres, which can be referred to as “humid cooking chamber atmosphere” M and “dry cooking chamber atmosphere” D is shown. For instance, the (more) humid cooking chamber atmosphere can be particularly suited to specific meals such as stews or dishes coated in herbs, while the dry(er) cooking chamber atmosphere can be particularly suited to meals in which herbs or other spices are to be added, which only develop their flavor in a dryer cooking chamber atmosphere.

The different cooking chamber atmospheres have different proportional factors y. Therefore before starting a cooking operation or cooking process, a user can define whether the cooking operation is to run with more humid or more dry conditions in the cooking chamber 2.

In one development, the proportional factor y with the selected dryer cooking chamber atmosphere is less than with the selected more humid cooking chamber atmosphere. However, the proportional factor y can essentially also be higher with a dryer cooking chamber atmosphere than with a more humid cooking chamber atmosphere.

In addition, the course of steps S1 to S5 or S1 to S6 for different cooking chamber atmospheres can also differ for instance that the proportional factor y remains constant for one of the cooking chamber atmospheres (e.g. for the more humid cooking chamber atmosphere), whereas it changes for another of the cooking chamber atmospheres (e.g. for the dryer cooking chamber atmosphere), e.g. as described in FIG. 3. In particular, with a changing proportional factor y, a proportional factor y which is changed after a second safety looping in step S4 can assume a “safety” value.

Moreover, the signs for the different cooking chamber atmospheres can differ. While, e.g. the signs for a more humid cooking chamber atmosphere can comprise signs that the threshold value and/or a safety sign has been reached, with a dry cooking chamber atmosphere at least one sign can also be output that the user can now add spices such as herbs etc. The spices/herbs can be placed e.g. in a small bowl, in the cooking chamber 2, in order for their aroma to be better absorbed by the food.

The signs are therefore generally not restricted to increasing the moisture in the cooking chamber 2 but can instead be general instructions in order to improve a cooking result. In general, the signs can also depend on the type of food or meal to be prepared in the cooking chamber 2. The type of food or meal can be entered directly by a user (by way of a control device of the household cooking appliance or by way of a user terminal) or can be determined by means of a cooking program.

The present invention is naturally not restricted to the exemplary embodiment shown.

In general, “a”, “one” etc. can be regarded as a singular or a plurality, in particular in the sense of “at least one” or “one or more” etc., as long as this is not explicitly excluded, e.g. by the expression “precisely one” etc.

In addition, a given number can include precisely the number given and also a typical tolerance range, as long as this is not explicitly excluded.

### LIST OF REFERENCE CHARACTERS

1 Household cooking appliance

2 Cooking chamber

3 Sensor

4 Control device

5 Cooking chamber door

f Current humidity value

fr Reference humidity value

D Dry cooking chamber atmosphere

M Humid cooking chamber atmosphere

S1-S7 Method steps

T Threshold value

t Point in time

Δt Waiting time

y Proportional factor

1-12. (canceled)

13. A method for operating a household cooking appliance with a cooking chamber, said method comprising:
monitoring a humidity value in the cooking chamber; and
outputting a sign when the humidity value reaches or falls below a predetermined threshold value.

14. The method of claim 13, wherein the sign comprises a suggestion to increase the humidity value in the cooking chamber.

15. The method of claim 14, wherein the household cooking appliance is configured without a steam generator.

16. The method of claim 14, wherein the increase of the humidity value in the cooking chamber is realized by manually triggering a steam boost via a steam generator of the household cooking appliance.

17. The method of claim 13, wherein the sign comprises a suggestion to add food to the cooking chamber.

18. The method of claim 13, further comprising:
continuing to monitor the humidity value in the cooking chamber after outputting the sign; and
outputting a further sign when the humidity value reaches or falls below a further predetermined threshold value.

19. The method of claim 13, further comprising:
determining a reference humidity value at a predetermined point in time; and
determining the threshold value from the reference humidity value, multiplied by a predetermined associated proportional factor.

20. The method of claim 13, further comprising determining reference humidity values at different points in time in order to determine different threshold values, each multiplied by a predetermined associated proportional factor.

21. The method of claim 20, further comprising determining different proportional factors in order to determine the different threshold values.

22. The method of claim 19, further comprising:
selecting initially a desired humidity level from a group of a number of predetermined humidity levels; and
setting the proportional factor as a function of the selected humidity level.

23. The method of claim 19, further comprising setting the proportional factor as a function of a selected cooking program.

24. A household cooking appliance, comprising:
a cooking chamber;
a sensor configured to determine a humidity in the cooking chamber; and
a control device operably connected to the sensor and outputting a sign when the humidity in the cooking chamber reaches or falls below a predetermined threshold value.

25. The household cooking appliance of claim 24, further comprising a manually operated steam generator to trigger a steam boost for increasing the humidity in the cooking chamber.

26. The household cooking appliance of claim 24, wherein the sensor continues to monitor the humidity value in the cooking chamber after the control device has output the sign, said control device outputting a further sign when the humidity value reaches or falls below a further predetermined threshold value.

27. The household cooking appliance of claim 24, wherein the control device is configured to determine the threshold value from a reference humidity value at a predetermined point in time, multiplied by a predetermined associated proportional factor.

28. The household cooking appliance of claim 24, wherein the control device is configured to determine reference humidity values at different points in time in order to determine different threshold values, each multiplied by a predetermined associated proportional factor.

29. The household cooking appliance of claim 28, wherein the control device is configured to determine different proportional factors in order to determine the different threshold values.

30. The household cooking appliance of claim 28, wherein the control device is configured to select a desired humidity level from a group of a number of predetermined humidity levels in response to querying a user, and to set the proportional factor as a function of the selected humidity level.

31. The household cooking appliance of claim 28, wherein the control device is configured to set the proportional factor as a function of a selected cooking program.

32. The household cooking appliance of claim 24, wherein the sign comprises a suggestion to increase the humidity value in the cooking chamber or to add food to the cooking chamber.
